(19) United States
(12) Patent Application Publication
(10) Pub. No.: US 2002/0175937 A1
(43) Pub. Date: Nov. 28, 2002

(54) Multiple locale based display areas

(76) Inventors: Jason Yi Blakely, Apex, NC (US); Robert Selby Sielken, Durham, NC (US)

Correspondence Address: Stephen J. Weed, Esquire, Synnestvedt & Lechner LLP, 2600 Aramark Tower, 1101 Market Street, Philadelphia, PA, 19107-2950, US

(21) Appl. No.: 09/864,547

(22) Filed: May 24, 2001

(51) Int. Cl. G06F 3/00; G06F 13/00

(52) U.S. Cl. 345/744; 345/746

(57) ABSTRACT

A method and graphical user interface (GUI) for displaying information in accordance with an associated locale. The method includes the steps of associating each of a plurality of sets of information with one of two or more locale designations and displaying and manipulating information in accordance with properties of the associated locale designations. The GUI includes display areas for displaying information associated with the locale designations. The present invention also encompasses a system and computer program product for associating locale designations with display information and displaying and manipulating the information in accordance with properties of the associated locale designation.

### FIELD OF THE INVENTION

The present invention relates to computer systems and, more particularly, to the presentation of information by computer systems.

### BACKGROUND OF THE INVENTION

Computer applications often require that computer systems display information in more than one language on a single screen. In language translation applications, for example, it is common to display words to be translated, i.e., “source” words, in one language and words after translation, i.e., “target” words, in another language. In addition, another language may be used for displaying controls and additional information, i.e., a “system” language. Each language has unique characteristics. Accordingly, systems and methods for appropriately displaying and handling multiple languages are desirable.

Presently, computer applications display different languages on a computer system display based on a single locale designation, e.g., the location where the user resides. The locale designation represents a particular geographic area and has associated properties which define how the information should be displayed and sorted. The locale designation will generally be associated with a character set which contains all of the characters for the language of the designated locale. In order to display other languages, additional characters are added to the character set. For example, in a translation application, if the source language is Spanish, the target language is French, and the system language is English, the display would display the Spanish, French, and English languages using a single locale designation, e.g., the locale designation of the USA. In this example, the locale designation would use a character set which contains English characters with additional characters added to display characters that are unique to the Spanish and French languages. This leads to system limitations related to displaying characters and ordering words within these systems.

In these applications, since only one locale designation is used, only one character set can be used. This can lead to improper display of certain characters. For example, if the source words are in Japanese, the target words are in Chinese, and the system language is in Korean and only one locale designation is used for display purposes, one character set (based on the one locale) would be selected for displaying all of the languages. In this example, a known character set such as the ShiftJIS character set which is used to display Japanese could be selected. In this character set, English characters are added to Japanese characters, punctuation marks, and numbers so that English can be mixed in with Japanese. The ShiftJIS character set, however, contains very few (if any) of the Chinese or Korean characters. So, if characters are displayed using only the ShiftJIS character set, the only characters which will be displayed correctly are the Japanese characters and the few (if any) Chinese or Korean characters that are the same as the Japanese characters. The other Chinese and Korean characters can't be displayed using ShiftJIS, so they show up as random Japanese characters/numbers/punctuation marks chosen from the ShiftJIS character set, rendering the displayed words unintelligible.

In addition, in applications using one character set, the sorting of information is based on that character set. Therefore, if the locale designation is the USA and the information to be displayed is a column containing words from the Spanish language, words within the column may be sorted incorrectly since they will be sorted as they would be sorted in the USA. For example, Spanish contains the character “á.” According to a USA locale designation this would be treated as a special character which would come somewhere after “z” in an alphabetically sorted order. In a Spanish locale designation sorted order, however, “á” would be located between “a” and “b.” Accordingly, Spanish words which begin with “á” would not be located where an operator would expect to find them if sorted according to a USA locale designation.

Since each locale's language may have its own unique characters and the characters may be handled differently in different locales, it is difficult to appropriately display and handle information from multiple locales. Accordingly, there is a need for improved methods and interfaces for displaying and handling information from multiple locales. The present invention fulfills this need among others.

### SUMMARY OF THE INVENTION

The present invention provides for a method of displaying information and a graphical user interface (GUI) which overcomes the aforementioned problems by displaying and manipulating information in accordance with locales associated with that information.

One aspect of the present invention is a method for displaying information in a display area including the steps of associating each of a plurality of sets of information with a locale designation and displaying the information in accordance with properties of the associated locale designations. In a preferred embodiment, the present invention farther includes the step of sorting the plurality of sets of information in accordance with properties of the associated locale designations.

Another aspect of the invention is a GUI for displaying information having a plurality of display areas for displaying information in accordance with properties of an associated locale designation. In addition, the present invention encompasses a system and computer program product for carrying out the inventive method.

### BRIEF DESCRIPTION OF THE DRAWINGS

FIG. 1 is a flow chart of a method for displaying information in accordance with the present invention;

FIG. 2 is a screen capture of a graphical user interface in accordance with the present invention;

FIG. 3 is a block diagram illustrating an exemplary data processing network in which the present invention may be practiced; and

FIG. 4 is a block diagram of a processing device in which the present invention may be practiced.

### DETAILED DESCRIPTION OF THE INVENTION

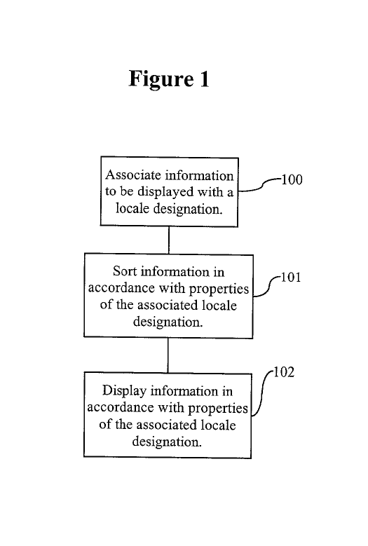

FIG. 1 depicts a method for displaying information on a display of a computer system in accordance with the present invention. The method includes associating information to be displayed with a locale designation and displaying the information in accordance with properties of the associated locale designation. In a preferred embodiment, the method further includes sorting the information in accordance with properties of the locale designation to permit searching according to usage in the locale corresponding to the locale designation associated with the information. In the preferred embodiment, properties of the locale designation define how the information should be displayed and sorted.

At step 100, information to be displayed in a display area is associated with a locale designation. In a preferred embodiment, the information is associated with a locale designation corresponding to that information. For example, if the information is English language text, the locale designation associated with that information may be the United States (USA); and if the information is Spanish language text, the locale designation associated with that information may be Spain. Properties of the locale designation define how the information should be displayed. For example, if the locale designation is the USA, a property of the locale designation would specify that an English character set would be used. In the preferred embodiment, at least two sets of information for display in different display areas are associated with different locale designations. For example, one set of information may be English text which is associated with the USA and the other set of information may be Spanish text which is associated with Spain. Associating information to be displayed with a locale designation can be performed using conventional programming techniques and, therefore, will not be described in detail.

At step 101, the information associated with a locale designation in step 100 is sorted in accordance with properties of its associated locale designation. In a preferred embodiment, properties of the locale designation, in addition to defining how information should be displayed, as discussed above, define how the information should be sorted. This allows the information associated with a locale designation to be sorted according to the usage in the locale corresponding to that locale designation. For example, if the information is a list of Spanish words, words beginning with “á” are sorted such that they are between words beginning with “a” and words beginning with “b” since the information can be sorted according to properties of its associated locale designation, i.e., Spain. Since, in the preferred embodiment, at least two sets of information for display in different display areas are associated with different locale designations, the information of each set can be sorted according to the corresponding locale designation. For example, English text can be sorted according to usage in the USA and Spanish text can be sorted according to usage in Spain. Sorting information in accordance with properties of its associated locale designation can be performed using conventional programming techniques. It is contemplated that if the information is for display only or if order is not important, step 101 can be eliminated.

At step 102, the information associated with a locale designation in step 100 is displayed in accordance with properties of its associated locale designation. In the present invention, information is displayed according to properties of the locale designation with which it is associated. Accordingly, information associated with a particular locale designation, e.g., the United States (USA), will be displayed using a character set from that locale, e.g., an English language character set. In addition, if the information was sorted according to the locale designation in accordance with step 101, the information can be displayed in a sorted order and searched in accordance with the usage in the locale corresponding to that locale designation. This gives the information the look and feel of the locale with which the information is associated, e.g., of an English system. Since, in the preferred embodiment, at least two sets of information for display in different display areas are associated with different locale designations, the information of each set can be displayed according to properties of the corresponding locale designation. Therefore, for example, English language text can be displayed and searched in one display area such that it will have the look and feel of a system in the USA and Spanish language text can be displayed and searched in another display area such that it will have the look and feel of a system in Spain. Displaying information in accordance with properties of its associated locale designation can be performed using conventional programming techniques.

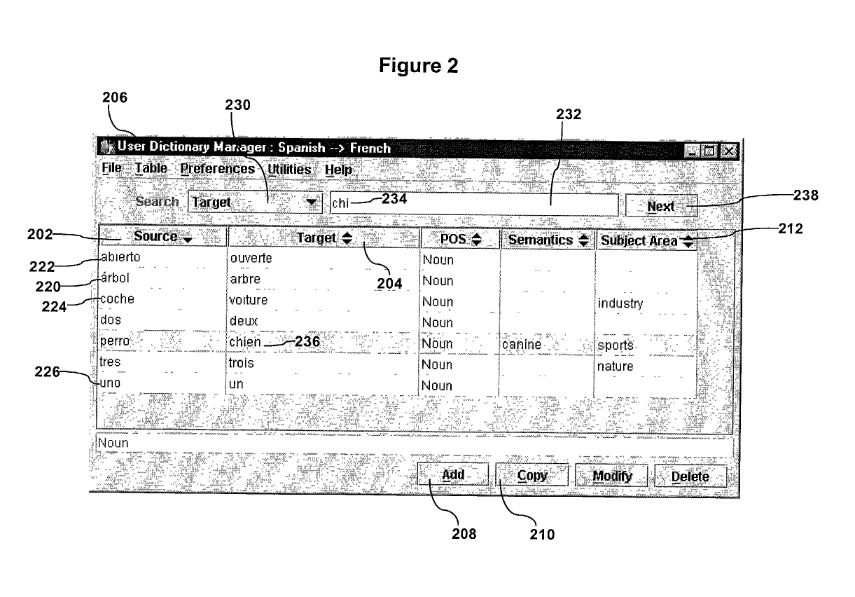

FIG. 2 depicts a graphical user interface (GUI for displaying information in accordance with the present invention. The GUI depicted in FIG. 2 is a GUI of a utility for use with a translation program which translates a word in one language having an associated locale designation (e.g., a “source” word in a display area under a source column heading 202) into a word in another language having an associated locale designation (e.g., a “target” word in a display area under a target column heading 204). In addition to the languages displayed under the source and target column headings 202 and 204, the GUI displays labels, button, and other display areas in a system language having an associated locale designation. In the preferred embodiment, the GUI is developed using conventional programming techniques. In this example, the source language is Spanish, the target language is French, and the system language is English.

Although the GUI of the present invention is described using a GUI for use with a translation program, the present invention can be utilized wherever languages of multiple locales are displayed on one display, and should not be construed to being limited to system display areas, source display areas, and target display areas. The present invention can be utilized essentially wherever there is the need to display information from two or more locales in accordance with their corresponding locales.

The GUI of FIG. 2 contains labels and buttons such as a title 206, an add button 208, and a copy button 210 which are associated with a system locale designation, i.e., the locale designation for the system on which the program is being used. In the present example, the system locale designation is the United States (USA). In addition, the GUI contains other display areas such as a subject area display area under the column heading “Subject Area” 212 which is also associated with the system locale designation.

In the present invention, the labels, buttons, and certain other display areas are displayed by the GUI according to properties of the locale designation with which they are associated. Accordingly, the labels, buttons, and other display areas which are associated with a particular locale designation, e.g., USA, will be displayed using a character set from that locale, e.g., an English language character set. In addition, as will be described in detail below in reference to the source display area, in a preferred embodiment, information displayed in the other display areas will be sorted and searchable according to properties of the particular locales associated with those display areas. This gives the information within a display area the look and feel of the locale corresponding to the locale designation with which the information is associated, e.g., of an English system. In a preferred embodiment, information which is not associated with a specific locale designation is associated with the system locale designation for display by the GUI.

The GUI of FIG. 2 contains another display area, e.g., the source display area under the source column heading 202, which is associated with a particular locale designation, e.g., Spain. Accordingly, the source display area will display information using a character set from that locale, e.g., a Spanish language character set. In addition, in the preferred embodiment, information displayed in the source display area will be sorted and searchable according to properties associated with the information to be displayed. For example, in the Spanish language character set, the character “á” is after “a” and before “b,” instead of a special character which would come somewhere after “z” in a USA system. Accordingly, words such as árbol 220 will be located between abierto 222 and coche 224 in the present invention, instead of after uno 226 in a USA system, since the information can be sorted according to properties of its associated locale designation rather than the locale designation of the system.

The GUI of FIG. 2 contains another display area, e.g., the target display area under the target column heading 204, which is associated with a particular locale designation, e.g., France. Accordingly, the target display area will display information using a character set from that locale, e.g., a French language character set. In addition, in the preferred embodiment, information displayed in the target display area will be sorted and searchable according to properties of the particular locale. This gives the information the look and feel of the locale with which the information is associated, e.g., of a French system. In accordance with certain embodiments, multiple target display areas with different locale designations may be displayed within the GUI of FIG. 2.

In the illustrated embodiment, a search function is available. A user performs a search by first selecting the column through which the user would like to search. This is accomplished by selecting a drop down menu associated with a button 230 currently labeled as “Target” (e.g., by clicking on it with a mouse). Selecting the button 230 produces a drop down menu containing the column headings for the displayed columns, i.e., the source column heading 202, target column heading 204, part of speech (POS) column heading, semantics column heading, and subject area column heading 212. In the illustrated embodiment, the target column heading 204 was selected which prompted the GUI to display “Target” on the button 230. The user then searches for a particular word within the column under the target column heading 204 by keying in parameters 234, e.g., the first few letters, of a desired word into a search box 232. As the user enters the parameters 234 into the search box 232, the GUI will jump to the first word 236 conforming to the search parameters 234 in the column under the target column heading 204 and, also, display words before and after the first conforming word 236. To select the next word in the column which conforms to the search parameters 234, the user selects a “next” button 238. Since, in accordance with the present invention, the information in the column under the target column heading 204 is associated with its locale designation, the next button 238 will take the user to the word which is the next word according to properties of the locale designation associated with the information displayed in the column under the target column heading 204. Likewise, if the user had selected the subject area column heading 212, the next button 238 would take the user to the next word according to properties of the locale designation associated with the information displayed under the subject area column heading 212.

Network

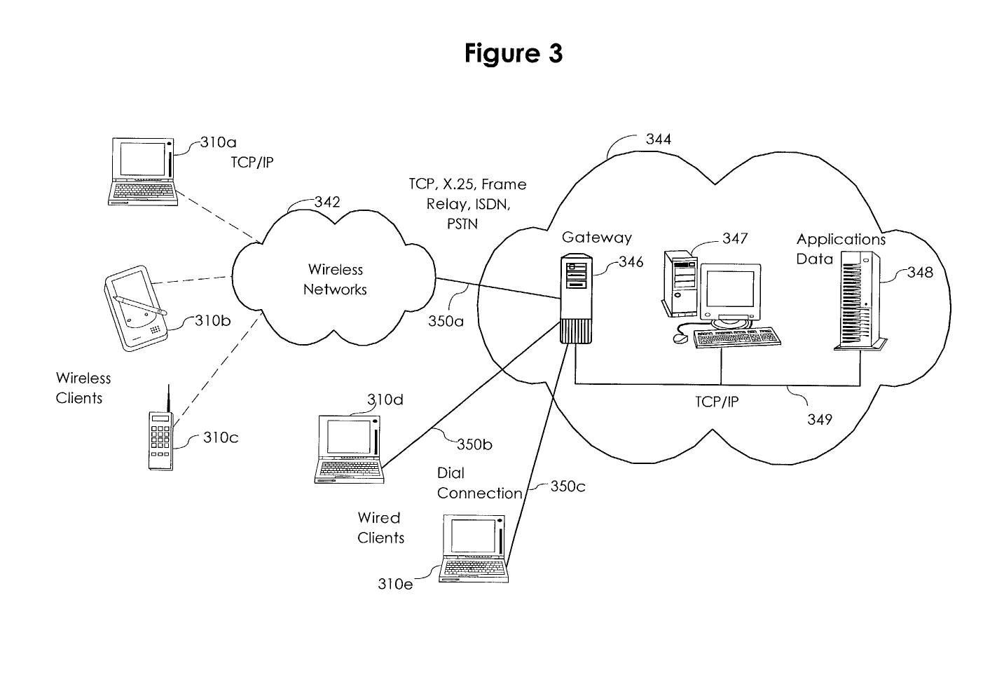

FIG. 3 illustrates an exemplary data processing network 340 in which the present invention may be practiced. The data processing network 340 may include a plurality of individual networks, such as wireless network 342 and network 344, each of which may include a plurality of individual workstations/devices, e.g. 310a, 310b, 310c. Additionally, as those skilled in the art will appreciate, one or more LANs may be included (not shown), where a LAN may comprise a plurality of intelligent workstations coupled to a host processor.

The networks 342 and 344 may also include mainframe computers or servers, such as a gateway computer 346 or application server 347 (which may access a data repository 348). A gateway computer 346 serves as a point of entry into each network 344. The gateway computer 346 may be preferably coupled to another network 342 by means of a communications link 350a. The gateway computer 346 may also be directly coupled to one or more workstations, e.g 310d, 310e using a communications link 350b, 350c. The gateway computer 346 maybe implemented using any appropriate processor, such as IBM's Network Processor. For example, the gateway computer 346 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390,” “Application System/400,” and “AS/400” are registered trademarks of IBM.) These are merely representative types of computers with which the present invention may be used.

The gateway computer 346 may also be coupled 349 to a storage device (such as data repository 348). Further, the gateway 346 may be directly or indirectly coupled to one or more workstations/devices 310d, 310e, and servers such as application server 347.

Those skilled in the art will appreciate that the gateway computer 346 may be located a great geographic distance from the network 342, and similarly, the workstations/devices may be located a substantial distance from the networks 342 and 344. For example, the network 342 may be located in California, while the gateway 346 may be located in Texas, and one or more of the workstations/devices 310 may be located in New York. The workstations/devices 310 may connect to the wireless network 342 using a networking protocol such as the Transmission Control Protocol/Internet Protocol (“TCP/IP”) over a number of alternative connection media, such as cellular phone, radio frequency networks, satellite networks, etc. The wireless network 342 preferably connects to the gateway 346 using a network connection 350a such as TCP or UDP (User Datagram Protocol) over IP, X.25, Frame Relay, ISDN (Integrated Services Digital Network), PSTN (Public Switched Telephone Network), etc. The workstations/devices 310 may alternatively connect directly to the gateway 346 using dial connections 350b or 350c. Further, the wireless network 342 and network 344 may connect to one or more other networks (not shown), in an analogous manner to that depicted in FIG. 3.

The present invention may be used on a client computer or server in a networking environment, or on a standalone workstation. (Note that references herein to client and server devices are for purposes of illustration and not of limitation: the present invention may also be used advantageously with other networking models.) When used in a networking environment, the client and server devices may be connected using a “wireline” connection or a “wireless” connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

Processing Device

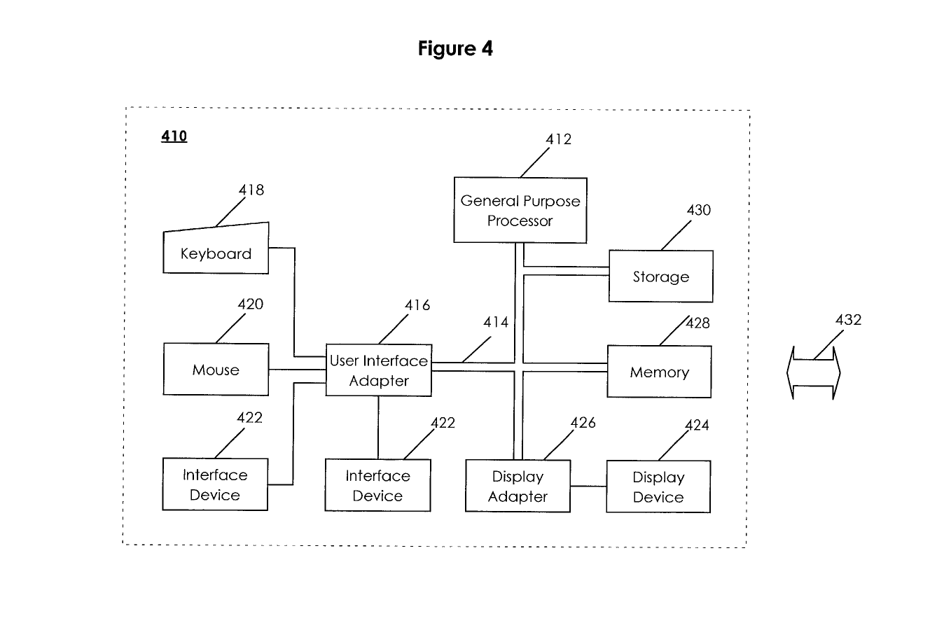

FIG. 4 is a block diagram of a processing device 410 in accordance with the present invention. The exemplary processing device 410 is representative of workstation 310a or server 346 of FIG. 3, as discussed above. This block diagram represents hardware for a local implementation or a remote implementation.

As is well known in the art, the workstation of FIG. 4 includes a representative processing device, e.g. a single user computer workstation 410, such as a personal computer, including related peripheral devices. The workstation 410 includes a general purpose microprocessor 412 and a bus 414 employed to connect and enable communication between the microprocessor 412 and the components of the workstation 410 in accordance with known techniques. The workstation 410 typically includes a user interface adapter 416, which connects the microprocessor 412 via the bus 414 to one or more interface devices, such as a keyboard 418, mouse 420, and/or other interface devices 422, which can be any user interface device, such as a touch sensitive screen, digitized entry pad, etc. The bus 414 also connects a display device 424, such as an LCD screen or monitor, to the microprocessor 412 via a display adapter 426. The bus 414 also connects the microprocessor 412 to memory 428 and long-term storage 430 (collectively, “memory”) which can include a hard drive, diskette drive, tape drive, etc.

The workstation 410 may communicate with other computers or networks of computers, for example, via a communications channel or modem 432. Alternatively, the workstation 410 may communicate using a wireless interface at 432, such as a CDPD (cellular digital packet data) card. The workstation 410 may be associated with such other computers in a LAN or a wide area network (WAN), or the workstation 410 can be a client in a client/server arrangement with another computer, etc. All of these configurations, as well as the appropriate communications hardware and software, are known in the art.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for displaying information in a display area comprising the steps of:
associating a first set of information with a first locale designation;
associating a second set of information with a second locale designation;
displaying data from said first set of information in accordance with properties of said first locale designation; and
displaying data from said second set of information in accordance with properties of said second locale designation, said data from said first and second set of information displayed simultaneously on the display area.

2. The method of claim 1, further comprising the steps of:
sorting said first set of information in accordance with properties of said first locale designation; and
sorting said second set of information in accordance with properties of said second locale designation.

3. The method of claim 2, wherein said first set of information is searchable in accordance with properties of said first locale designation and said second set of information is searchable in accordance with properties of said second locale designation.

4. The method of claim 1, wherein said step of displaying data from said first set of information comprises displaying data from said first set of information in a character set associated with said first locale designation; and said step of displaying data from said second set of information comprises displaying data from said second set of information in a character set associated with said second locale designation.

5. The method of claim 1, wherein said first locale designation and said second locale designation are different.

6. The method of claim 2, wherein said first locale designation is a system locale designation.

7. The method of claim 1, further comprising the step of:
displaying data from a third set of information associated with a third locale designation, said data from said third set of information displayed simultaneously with said first and second set of data on the display area.

8. The method of claim 7, further comprising the steps of:
sorting said first set of information in accordance with properties of said first locale designation;
sorting said second set of information in accordance with properties of said second locale designation; and
sorting said third set of information in accordance with properties of said third locale designation.

9. The method of claim 8, wherein said first set of information is searchable in accordance with properties of said first locale designation, said second set of information is searchable in accordance with properties of said second locale designation, and said third set of information is searchable in accordance with properties of said third locale designation.

10. The method of claim 7, wherein said step of displaying data from said first set of information comprises displaying data from said first set of information in a character set associated with said first locale designation; said step of displaying data from said second set of information comprises displaying data from said second set of information in a character set associated with said second locale designation; and said step of displaying data from said third set of information comprises displaying data from said third set of information in a character set associated with said third locale designation.

11. The method of claim 8, wherein said first locale designation is a system locale designation.

12. The method of claim 7, wherein said first, second, and third locale designations are different.

13. A graphical user interface (GUI) comprising:
a first display area for displaying data from a first set of information in accordance with properties of a first locale designation; and
a second display area for displaying data from a second set of information in accordance with properties of a second locale designation.

14. The GUI of claim 13, wherein said first and second locale designations are different.

15. The GUI of claim 14, wherein said first locale designation is a system locale designation.

16. The GUI of claim 13, wherein the data from said first set of information displayed in said first display area is sorted in accordance with properties of said first locale designation and the data from said second set of information displayed in said second display area is sorted according in accordance with properties of said second locale designation.

17. The GUI of claim 13, further comprising:
a third display area for displaying data from a third set of information, said third set of information associated with a third locale designation.

18. The GUI of claim 17, wherein said first, second, and third locale designations are different.

19. The GUI of claim 17, wherein said first locale designation is a system locale designation, said second locale designation is a source locale designation, and said third locale designation is a target locale designation.

20. The GUI of claim 17, wherein said system locale designation, said source locale designation, and said target form part of a translation system interface.

21. The GUI of claim 17, wherein said first locale designation is associated with at least a first character set, said second locale designation is associated with at least a second character set, and said third locale designation is associated with at least a third character set.

22. The GUI of claim 17, wherein the data from said first set of information displayed in said first display area is sorted in accordance with properties of said first locale designation, the data from said second set of information displayed in said second display area is sorted in accordance with properties of said second locale designation, and the data from said third set of information displayed in said third display area is sorted in accordance with properties of said third locale designation.

23. A graphical user interface (GUI) comprising:
a plurality of display areas;
a first of said display areas for displaying source information associated with a source locale designation;
one or more of said display areas for displaying target information, each of said one or more of said display areas for displaying target information corresponding to one of one or more target locale designations; and
other display areas not associated with said source locale designation or said one or more target locale designations associated with a system locale designation.

24. The GUI of claim 23, wherein:
said first of said display areas can be sorted and searched in accordance with properties of said source locale designation;
said one or more of said display areas can be sorted and searched in accordance with properties of corresponding ones of said one or more target locale designations; and
said other display areas can be sorted and searched in accordance with properties of said system locale designation.

25. A system for displaying information associated with multiple locales, said system comprising:
means for associating a first set of information with a first locale designation and a second set of information with a second locale designation; and
means for displaying said first and second set of information.

26. The system of claim 25, further comprising:
means for sorting said first set of information in accordance with properties of said first locale designation and sorting said second set of information in accordance with properties of said second locale designation; and
means for searching said first and second sets of information.

27. The system of claim 25, further comprising:
means for associating a third set of information with a third locale designation; and
means for displaying said third set of information, said third set of information being displayed simultaneously with said first and second set of information.

28. The system of claim 27, further comprising:
means for sorting said third set of information in accordance with properties of said third locale designation; and
means for searching said third set of information.

29. A computer program product for displaying information associated with multiple locales, said computer program product comprising:
computer readable program code embodied in a computer readable medium, the computer readable program code comprising at least:
computer readable program code for associating a first set of information with a first locale designation and a second set of information with a second locale designation; and
computer readable program code for displaying said first set of information associated with said first locale designation and said second set of information associated with said second locale designation.

30. The computer program product of claim 29, further comprising:
computer readable program code for sorting said first set of information in accordance with properties of said first locale designation and sorting said second set of information in accordance with properties of said second locale designation; and
computer readable program code for searching said first and second sets of information.

31. The computer program product of claim 29 wherein said computer readable program code embodied in a computer readable medium further comprises:
computer readable program code for associating a third set of information with a third locale designation; and
computer readable program code for displaying said third set of information associated with said third locale designation.

32. The computer program product of claim 31, further comprising:
computer readable program code for sorting said third set of information in accordance with properties of said third locale designation; and
computer readable program code for searching said first and second sets of information.
